(19) United States
(12) Patent Application Publication
(10) Pub. No.: US 2010/0009853 A1
(43) Pub. Date: Jan. 14, 2010

(54) PARASITIC PLANT CONTROL AGENT AND USE THEREOF

(75) Inventors: Osamu Ikeda, Tokyo (JP); Ken Kuriyama, Tokyo (JP); Miyako Aoki, Tokyo (JP); Masao Yamashita, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Nihon Nohyaku Co., Ltd, Tokyo (JP)

(21) Appl. No.: 12/373,538

(22) PCT Filed: Jul. 13, 2007
(86) PCT No.: PCT/JP2007/063999

§ 371 Date: Jan. 13, 2009

(30) Foreign Application Priority Data
Jul. 13, 2006 (JP) 2006 193083

(51) Int. Cl. A01N 43/40; A01N 43/80; A01N 43/72; A01P 13/00

(52) U.S. Cl. 504/260; 504/269; 504/261

(57) ABSTRACT

Parasitic plants parasitizing on crops can be controlled effectively, by providing an agent for controlling parasitic plants, which comprises tiadinil or the like as the active ingredient and a method for using an agent for controlling parasitic plants, which comprises treating a parasitized plant or soil with an effective amount of agent for controlling parasitic plants. As a result, the yield of crops can be recovered to the level of parasitism-free crops. Additionally, by inhibiting parasitism of parasitic plants strongly, development of the next generation can be inhibited so that the level of pollution with parasitic plants on agricultural land can be lowered with cultivating sensitive crops.

### TECHNICAL FIELD

The present invention relates to an agent for controlling parasitic plant and use thereof.

### BACKGROUND OF THE INVENTION

Parasitic plants such as the genus Striga (scientific name: Striga, English name: witchweed) of the family Scrophulariaceae, the genus Orobanche (scientific name: Orobanche, English name: broomrape) of the family Orobanchaceae and the like are distributed in the dry zones belonging to the tropical or subtropical regions of Africa and West Asia. A great variety of crops including cereals, beans, an eggplant, a tomato, a tobacco and the like are damaged by these parasitic plants. A parasitic plant lives on a root part and the like to sack nourishment gradually, and grows up sooner or later to greatly reduce the yield of the crops. These are not noticed at the early stage since they are not noticeable for the short height. Thus, when control of these parasitic plants is delayed, they produce flowers and bear 100,000 or more of very fine seeds.

The seeds wait without germination until run into a host plants. Since they survive without germination for 10 years or more in some cases, their control is extremely difficult to attain. In some regions in Africa, parasitic plants such as Striga and the like are becoming the greatest biological threat surpassing insects and disease injuries. Particularly, there is present a problem in that breed-improved high-yield crops become sensitive to parasitic plants. Caused by the transfer and the like of polluted seeds, the damage of crops by parasitic plants is also expanding recently through Europe and Australia.

As a method for protecting crops from parasitic plants, their control by an agricultural technique has been carried out conventionally, in which the density of parasitic plants is reduced by carrying out a crop rotation with a crop, so-called trap crop, which accelerates germination of the parasitic plants but hardly undergoes parasitism, in combination with leaving field fallow.

However, since the once produced seeds are rich in numbers and survive over a long years as described in the above, their control is difficult to attain once polluted with the parasitic plants. Recently, a controlling method by a combination with a trap crop or the like, making use of a herbicide having selectivity for crops (e.g., ALS inhibitors, used in the fields of cereals and beans) has been carried out. Also, a controlling method effected by inducing a so-called suicide germination, using a germination accelerating substance making use of its characteristic nature as the host-specific germination, (e.g., see Patent References 1 to 3) and the like have also been proposed. Additionally, from the side of crops, breeding of resistant crops, creation of crops having less production of germination inducing substances and the like have also been carried out.

### Patent Reference 1: JP-A-10-251243

### Patent Reference 2: JP-A-11-139907

### Patent Reference 3: JP-A-11-139908

### DISCLOSURE OF THE INVENTION

### Problems that the Invention is to Solve

An agent for controlling parasitic plant having high effect to control parasitic plants, moreover by a convenient treatment, and is excellent in cost performance is required. Additionally, furthermore, even in the case of breed-improved crops, an agent for controlling parasitic plant and a controlling method which enables to obtain high yield without undergoing influences of parasitic plants are required.

Herbicides have limitations on the applicable crops due to their selectivity. Also, parasitic plant-resistant crops are not effective for physiological mutants of parasitic plants, so that it cannot be said as a stable treating method. The suicide germination inducing substances are still not at a satisfactory level. Additionally, in the case of the crops having less suicide germination inducing substance production, their yields are not equal so far to those of general species, and since these are not accepted in places other than the polluted fields by parasitic plant, they are not: broadly cultivated until the pollution progresses, so that they do not become the complete resolution.

The present invention aims at providing an agent for controlling parasitic plant and a method for using the same, which can effectively control parasitic plants that live on crops.

### Means for Solving the Problems

With the aim of solving the above-mentioned problems, the inventors of the present invention have carried out intensive studies and found as a result that parasitism of a parasitic plant to the crops of interest can be inhibited by treating seeds, stems, leaves or roots of the crops, or peripheral soils cultivating the crops, with an agent for controlling parasitic plant which uses tiadinil or the like compound as the active ingredient. Thus, the present invention was accomplished.

Namely, the present invention relates to:

[1] An agent for controlling a parasitic plant, which comprises 1 or 2 or more of compounds selected from tiadinil, probenazole, 2-chloroisonicotinic acid and isotianil, as the active ingredient;

[2] The agent for controlling parasitic plant according to [1], wherein the object to be controlled is a root-parasitic plant;

[3] The agent for controlling parasitic plant according to [2], wherein the root-parasitic plant is the genus Striga or the genus Orobanche;

[4] The agent for controlling parasitic plant according to any one of [1] to [3], wherein the active ingredient is tiadinil;

[5] A method for using an agent for controlling parasitic plant, which comprises treating a parasitized plant or soil with an effective amount as the active ingredient of the agent for controlling parasitic plant described in any one of [1] to [4];

[6] The method for using an agent for controlling parasitic plant according [5], wherein the treatment of a parasitized plant or soil is such a soil treatment that the parasitized plant can absorb the active ingredient from the root parts;

[7] The agent for controlling parasitic plant according to any one of [1] to [4], wherein from 0.01 to 60% by weight of the active ingredient is contained based on the agent for controlling parasitic plant;

[8] The agent for controlling parasitic plant according to [7], wherein from 0.1 to 50% by weight of the active ingredient is contained based on the agent for controlling parasitic plant;

[9] The method for using an agent for controlling parasitic plant described in [5] or [6], wherein amount of the active ingredient is from 5.0 to 5000 g per 1 hectare.

### EFFECT OF THE INVENTION

By the use of the agent for controlling parasitic plant of the present invention, the yield of crops can be recovered to the level of parasitism-free crops. This is the same in the case of cultivating the crops having high sensitivity to parasitic plants.

Additionally, by inhibiting parasitism of parasitic plants at a high level, development of the next generation can be inhibited. Namely, since the level of pollution of a farm with seeds of parasitic plants can be lowered, crops car be cultivated continuously. Furthermore, the controlling effect is increased when the treatment is repeated in each crop cultivation at such a level that, it does not cause formation of flower buds of the parasitic plants.

### BEST MODE FOR CARRYING OUT THE INVENTION

The following illustratively describes the agent for controlling parasitic plant of the present invention and its production method.

Although examples of the active ingredient include tiadinil (general name, to be referred to as “TDN”), probenazole (general name, to be referred to as “PBZ”), 2-chloroisonicotinic acid (chemical name, to be referred to as “INA”), isotianil (general name, chemical name: N-(2-cyanophenyl)-3,4-dichloroisothiazole-5-carboxamide, to be referred to as “CICA”) and the like, it is not particularly limited thereto. Preferable active ingredient is tiadinil, probenazole or isotianil. Since these compounds are compounds which have particularly high acceptable concentration for crops; hardly cause damage by chemicals; and therefore can be used at a high concentration, these are suited for the control and thorough control at a generated farm. Most of these active ingredients to be used in the present invention have a common function feature as resistance inducing agent of host plants and have a registration as an agricultural germicide. However, among the compounds having such function, salicylic acid did not show a desirable result but rather showed strong drug-induced phytotoxicity and not so high parasitic plant controlling activity. It is necessary to select a suitable compound depending on the kind of crops to be applied. Tiadinil is a particularly preferable compound as a compound having low phytotoxicity for crop plants, which also shows high controlling effect from the viewpoint of activity.

These active ingredients are conventionally known compounds described, for example, in references such as Pesticide Manual (The Pesticide Manual Thirteenth Edition 2003) and the like. Isotianil (N-(2-cyanophenyl)-3,4-dichloroisothiazole-5-carboxamide) is a compound described in JP-T-2001-522840 (Production Example No. 1).

Active ingredient of the agent for controlling parasitic plant of the present invention can be blended at an optional ratio according to the dosage forms. Blending ratio of the active ingredient in the composition is preferably from 0.01 to 60% by weight, more preferably from 0.1 to 50% by weight, based on the total amount of the agent for controlling parasitic plant.

Additionally, 1 or 2 or more of other agricultural chemical components can be added as active ingredients to the agent for controlling parasitic plant of the present invention, if necessary. Examples of the other agricultural chemical components include a herbicide, a germicide, an insecticide, a plant growth regulator, an insect growth regulator and the like. By adding these agricultural chemical components and the like, a synergistic effect can be obtained. For example, Striga lives mainly on grass family. By the use for example of a sulfonylurea or imidazolinnone, which is dicotyledonous (broad-leaved) weeds-selectively controlling herbicide, growth of germinated Striga can be inhibited, and the controlling efficiency can be improved by its synergism with the inhibition of Striga invasion into host roots by the agent for controlling parasitic plant of the present invention.

The agent for controlling parasitic plant of the present invention can be supported by liquid or solid carrier and produced and used in accordance with a usual method for agricultural chemical formulations.

The solid carrier which can be used in producing the agent for controlling parasitic plant of the present invention is classified into a non-water-soluble solid carrier and a water-soluble solid carrier. Examples of the non-water-soluble solid carrier include for example, clay, calcium carbonate, talc, bentonite, baked diatomaceous earth, unbaked diatomaceous earth, hydrous silicic acid, cellulose, pulp, chaff, wood flour, kenaf flour and the like. Also, examples of the water-soluble solid carrier include inorganic salts such as ammonium sulfate, sodium chloride, potassium chloride and the like, saccharides such as glucose, sucrose, fructose, lactose, urea, a urea formalin condensate, an organic acid salt, water-soluble amino acids and the like can be cited. These solid carriers may be used alone or by mixing two or more species. Amount of these solid carriers to be added is generally from 0.5 to 99.79% by weight, preferably from 20 to 98% by weight, based on the total amount of the parasitic plant controlling agent.

Although the liquid carrier is not particularly limited as long as it is within such a range that it does not generate drug-induced phytotoxicity, example there of include water, alcohols (e.g., methanol, ethanol, isopropanol, butanol, cyclohexanol, ethylene glycol, diethylene glycol, propylene glycol, hexylene glycol, polyethylene glycol, polypropylene glycol and the like), ketones (e.g., methyl isobutyl ketone, diisobutyl ketone, cyclohexanone, γ-butyrolactone and the like), ethers (e.g., Cellosolve and the like), aliphatic hydrocarbons (e.g., kerosene, mineral oil and the like), aromatic hydrocarbons (e.g., xylene, solvent naphtha, alkyl naphthalene and the like), esters (e.g., diisopropyl phthalate, dibutyl phthalate, dioctyl phthalate, an adipic acid ester and the like), amides (e.g., dimethylformamide, diethylformamide, dimethylacetamide and the like), dimethyl sulfoxides, nitrogen-containing carriers (e.g., N-alkyl pyrrolidone and the like) or oils and fats (e.g., rapeseed oil, soybean oil, olive oil, corn oil, coconut oil, castor oil and the like) and the like. Amount of these liquid carriers to be added is generally from 0.5 to 99.79% by weight, preferably from 20 to 98% by weight, based on the total amount of the parasitic plant controlling agent.

Additionally, in order to exert drug effects of the agricultural chemical components to be contained to the maximum and to improve quality of the agent for controlling parasitic plant, various auxiliary components such as a surfactant, a binder, a pulverization assistant, an absorbent, a stabilizing agent, a pigment and the like are added to the agent for controlling parasitic plant of the present invention, if necessary. Additionally, it is necessary to determine their selection and blending ratio in such a manner that they fit to the properties of the active ingredients to be used.

Examples of the surfactant which can be added to the agent for controlling parasitic plant of the present invention include nonionic surfactants such as polyoxyethylene alkyl ether, polyoxyethylene polystyryl phenyl ether, polyoxyethylene alkyl ester, polyoxyethylene sorbitan alkyl ester and the like, anionic surfactants such as alkyl naphthalene sulfonate, alkyl sulfate, polyoxyethylene polystyryl phenyl ether sulfate, polyoxyethylene alkyl ether sulfonate, polyoxyethylene polystyryl phenyl ether phosphate, dioctyl sulfosuccinate and the like, and the like.

Examples of the binder which can be used in producing the agent for controlling parasitic plant of the present invention include natural, semi-synthetic and synthetic polymers and the like. Examples of the natural one include starch, gum arabic, tragacanth gum, guar gum, mannan, pectin, sorbitol, xanthan gum, dextran, gelatin, casein and the like. Also, examples of the semi-synthetic one include dextrin, soluble starch, oxidized starch, α starch, methyl cellulose, ethyl cellulose, carboxymethyl cellulose, hydroxymethyl cellulose, hydroxyethyl cellulose, hydroxypropyl cellulose and the like. Examples of the synthetic one include polyvinyl alcohol, polyacrylamide, polyvinyl pyrrolidone, sodium polyacrylate, ethylene-acrylic acid copolymer, maleic anhydride copolymer, polyethylene glycol and the like. However, there is no limitation to these. Additionally, it is possible to use one species of them alone or two or more species in combination. The amount to be added is generally from 0.1 to 20% by weight, preferably from 0.3 to 10% by weight, based on the total amount of the agent for controlling parasitic plant.

Although the pulverization assistant is not particularly limited, examples thereof include carriers which use ores as the materials such as bentonite, zeolite, talc, acid clay, activated clay and the like, synthetic carriers such as white carbon (silica) and the like, plant carriers such as saccharides, dextrin, powder cellulose and the like, surfactants such as anionic surfactant and the like, other organic compounds, resins and the like.

As the absorbent, an auxiliary agent to be used in powdering or premixing oily liquid agricultural chemical bulk is used, and a mineral, vegetable or chemical fine powder having high absorbing ability and oil absorbing ability is also added for the purpose of absorbing liquid component and also providing fluidity of granules. The absorbent is also a so-called carrier (filler), and a carrier having high oil absorbing ability is appropriate as a powdering assistant. Examples thereof include oil-absorbing fine powder such as white carbon, diatomaceous earth, microcrystalline cellulose and the like, and the like.

Examples of the stabilizing agent include antioxidant such as butylhydroxy-toluene (BHT), butylhydroxyanisole (BHA) or the like and ultraviolet absorbent such as a hydroquinone ultraviolet absorbent, a salicylic acid ultraviolet absorbent, a benzophenone ultraviolet absorbent, a benzotriazole ultraviolet absorbent, a cyanoacrylate ultraviolet absorbent or the like.

Examples of the pigment include Red No. 202, iron oxide, titanium oxide and the like, although it is not particularly limited.

Other components can be mixed or concomitantly used with the agent for controlling parasitic plant of the present invention. For example, a repellent and other components can be contained therein for the purpose of avoiding its ingestion (including drinking by mistake) by animals including birds in carrying out a seed treatment. Examples of the repellent include odorous compounds such as a naphthalene compound and the like, ingestion inhibitors such as castor oil, pine resin, polybutane, diphenylamine pentachlorophenol, quinone, zinc oxide, an aromatic solvent and the like, bitter substances such as N-(trichloromethylthio)-4-cyclohexene-1,2-carboximide, anthraquinone, copper oxalate, turpentine oil and the like, herb oils such as p-dichlorobenzene, aryl isothiocyanate, amyl acetate, anethole, orange oil, cresols, geranium oil, lavender oil and the like, menthol, methyl salicylate, nicotine, pentanethiol, pyridines, tributyltin chloride, thiram, ziram, a carbamate system insecticide (e.g., methiocarb or the like), guazatine, a chlorinated cyclodiene insecticide (e.g., endrin or the like), an organic phosphorus insecticide (e.g., fenthion or the like) and the like. Examples of a toxic substance or a growth inhibitor (sterilization agent) as an other component include 3-chloro-4-toluidine hydrochloride, strychnine 20,25-diazacholesterol hydrochloride (code name: SC-12937) and the like.

When the agent for controlling parasitic plant of the present invention is used, it may be used by preparing into an appropriate dosage form in accordance with a usual method for agricultural chemical formulations. For example, it may be used by mixing with a solid carrier, a liquid carrier and a surfactant, as well as an auxiliary and the like according to the necessity, and preparing into granules, wettable powders, powders, floables, emulsions, solutions, suspensions, water dispersible granules and the like dosage forms.

As the parasitic plants, many kinds are known, and there are semi-parasitic ones which have chloroplast and totally parasitic ones which do not have chloroplast and depend their all nutrition on the host plants. They may be any of them, and example thereof include Santalales such as Viscaceae, Loranthaceae and the Misodendraceae, Santalaceae such as Santalum, Paris, Thesium and the like, Eremolepidaceae, the Olacaceae, the Opiliaceae, the Cynomoriaceae and the Balanophoraceae, and Rafflesiales such as Rafflesiaceae, the Mitrastemonaceae and Hydnoraceae, as well as Cassytha filiformis of Lauraceae, Krameriaceae, Lennoaceae, Convolvulaceae such as Cuscuta japonica, Cuscuta australis and the like, some of Scrophulariaceae (Pedicularis resupinata, Melampylrum ciliare, Euphrasia iinumae, Striga asiatica (scientific name), Striga hermonthica haustorium (scientific name, English name: purple witchweed), Striga densiflora (scientific name), Striga gesnenioide (scientific name), Striga Lour (scientific name) and the like) and Orobanchaceae such as Orobanche coerulescens, Yaseutsubo (Japanese name, scientific name: Orobanche minor), Aeginetia indica, Orobanche cumana (scientific name) and Orobanche ramosa (scientific name) and the like.

Although the parasitic plants for which the agent for controlling parasitic plant of the present invention is effective is not particularly limited, those which cause damage to the edible crop are important, such as genus Striga of Scrophulariaceae, genus Orobanche of Orobanchaceae, genus Cuscuta of Cuscutaceae, the Visacaceae, genus Viscum of Loranthaceae and the like. Among these, it is particularly useful for the plants of genus Orobanche as parasitic plants of Orobanchaceae, the plants of genus Striga (English name Witchweeds) as parasitic plants of Scrophulariaceae and the like. Although the parasitizing part may be roots or may be leaves and stems, in the case of the soil treatment as a preferable embodiment of the present invention, particularly high effect can be exerted on the root-parasitic parasitic plants (root-parasitic plants). The above-mentioned plants of genus Orobanche of Orobanchaceae, the plants of genus Striga of Scrophulariaceae and the like are root-parasitic.

The plants to which the agent for controlling parasitic plant of the present invention can be applied are not particularly limited as long as they are plants on which parasitic plants can live, since the hosts are limited in many cases to specific ones depending on the parasitic plant, but there also is a case of parasitizing on a large variety of plants depending on the species. For example, plants of Poaceae, plants of Solanaceae and plants of Fabaceae, as well as plants of Apiaceae such as parsley, celery, carrot and the like, plants of Cucurbitaceae such as cucumber, melon and the like, plants of Asteraceae such as sunflower, plants of Geraniaceae such as geranium and the like, plants of Brassicaceae such as turnip, Japanese radish, rapeseed, lettuce and the like, and the like also become the objects. Preferable examples are the plants of Poaceae such as corn, sorghum, sugar cane, wheat, rice and the like, plants of Solanaceae such as tomato, eggplant, green pepper, paprika, potato, capsicum, tobacco and the like, plans of Fabaceae such as soybean, adzuki bean, peanut, garden pea, kidney bean, cowpea, broad bean, lentil, alfalfa, red clover and the like and the like.

The agent for controlling parasitic plant of the present invention is particularly suited for its use at farming lands such as paddy field, upland field, meadow and the like. In other case, it can also be used for controlling parasitic plants at, for example, grassy places in a park and the like, an orchard, a forestry ground, a forest, a developed woods and the like. The present invention can be applied not only to these embodiments but also to every place and the parasitic plants of interest in response to the purposes in order to control undesirable parasitic plants.

Regarding the application method, it can be applied by the same methods for general agricultural chemicals. Examples thereof include direct application of granules and the like by hands, treatment of granules, powders or formulations diluted with water or the like or made into liquid without dilution by a hand applicator, a power applicator, a knapsack type power applicator, a wheel type power applicator, a tractor-mounted type applicator, aircraft applicator such as a manned or unmanned helicopter or the like and the like. Examples of the treatment methods include a seed treatment (seed dust coating, coating, seed soaking or the like), a soil treatment, a foliage treatment of the crops of interest (parasitized plants) and the like and is not particularly selected. However, it is necessary that it is a method absorbable by the crops of interest (parasitized plants). Examples of the soil treatment method for effecting absorption from the roots of parasitized plants include a soil irrigation treatment in which a liquid concentrate of formulations or a diluted liquid of respective formulations which has prepared is directly applied to the plant foot, a mixing treatment of granules, wettable powders and the like solid formulations with soil, a mixing treatment by soil covering at the time of seeding or the like, a plant foot application, charging into field water and the like. A preferable result cannot be obtained by a method for directly treating a parasitic plant alone. Preferable method is the irrigation treatment of soil with agents liquid or the like. The seed treatment is also a preferable treating method.

Regarding treating amount of the agent for controlling parasitic plant of the present invention, it may be used by appropriately selecting from a range of from 5.0 to 5000 g as the amount of the active ingredient, per 1 hectare. Preferably, it is from 20 to 2000 g per 1 hectare, more preferably about 200 g per 1 hectare. Although applying amount of the agent for controlling parasitic plant to be used in the present invention varies depending on the blending ratio of the active ingredient compounds, weather conditions, shape of the formulation, application period, application method, application place, disease injury to be controlled and the like, it may be applied by appropriately selecting from a range of generally from 0.0001 to 40%, preferably within a range of from 0.001 to 10%, as the active ingredient compound per seed weight. In the case of the general treatment with granules or powders or application to seeds, there are cases in which seed dust coating, seed soaking, seed coating and the like formulations are applied without: dilution or under a condition of high concentration.

### EXAMPLES

Although the following describes specific examples of the present invention, the present invention is not limited to these examples. In this connection, the “part” in the following Examples and comparative examples means “part by weight”.

### Formulation Example 1

| | |
|---|---|
| Tiadinil | 10 parts |
| Xylene | 70 parts |
| N-methyl pyrrolidone | 10 part |
| Mixture of polyoxyethylene nonyl phenyl ether | 10 parts |
| and calcium alkylbenzenesulfonate | |

The above were uniformly mixed and dissolved to make into emulsions.

### Formulation Example 2

| | |
|---|---|
| Tiadinil | 3 parts |
| Clay powder | 82 parts |
| Diatomaceous earth powder | 15 parts |

The above were uniformly mixed and pulverized to make into powders.

### Formulation Example 3

| | |
|---|---|
| Probenazole | 5 parts |
| Mixed powder of bentonite and clay | 90 parts |
| Calcium lignosulfonate | 5 parts |

The above were uniformly mixed, kneaded by adding an appropriate amount of water, granulated and dried to obtain granules.

### Formulation Example 4

| | |
|---|---|
| N-(2-cyanophenyl)-3,4-dichloroisothiazole-5- | 20 parts |
| carboxamide | |
| Kaolin and synthetic high dispersion | 75 parts |
| silicic acid | |
| Mixture of polyoxyethylene nonyl phenyl ether and | 5 parts |
| calcium alkylbenzenesulfonate | |

The above were uniformly mixed and pulverized to obtain wettable powders.

### Production Example 5

| | |
|---|---|
| Tiadinil | 10 parts |
| Calcium lignosulfonate | 5 parts |
| Sodium lauryl sulfate | 3 parts |
| Xanthan gum | 0.2 part |
| White carbon | 5 parts |
| Water | 76.8 parts |

The above were mixed and subjected to wet pulverization to make into suspensions.

### Production Example 6

| | |
|---|---|
| Tiadinil | 20 parts |
| Polyethylene glycol dialkyl aryl ether | 5 parts |
| sulfuric acid ester | |
| Calcium lignosulfonate | 10 parts |
| Diatomaceous earth | 65 parts |

The above were thoroughly nixed and pulverized and then mixed and kneaded by adding a small amount of water, subjected to granulation using an extrusion granulating machine and dried to make into water dispersible granules.

Tests were carried out on agents for controlling parasitic plant by the following methods. As the agents to be used, tiadinil (TDN), probenazole (PBZ), salicylic acid (SA), 2-chloroisonicotinic acid (INA) and isotianil (CICA, CAS registration number 224049-04-1) were used.

### Test Example 1

### Seed Soaking Treatment

### Method

Red clover seeds were soaked for 24 hours in agent liquid which had been prepared into a predetermined concentration. The red clover seeds were sowed in a pot packed with soil (1/10000 ares) and Orobanche minor seeds were sowed around the red clover seeds, followed by cultivation in a greenhouse. Growth of the red clover and the parasitism frequency and growth of Orobanche minor were observed by visual observation. The growth of Orobanche minor was evaluated based on the following four steps.

TABLE 1
Parasitic plant growth stages

| | |
|---|---|
| S1 | Small tuber of 2 mm or less |
| S2 | Small tuber of 2 mm or more |
| S3 | Formation of adventitious root grown to a certain level |
| S4 | Bud formation |

### Results

A reducing tendency was found on the number of total parasitized cases of Orobanche minor, by the treatment with 20 ppm of TDN and 200 ppm of INA. Additionally, reduction of the S4 (bud formation) by INA treatment was large.

TABLE 2
Test on the effect on parasitism of Orobanche minor on red clover
(Seed soaking treatment)

| | | Average | |
|---|---|---|---|
| | Treatment | parasitism | S4 bud |
| | concentration | frequency | formation |
| Agent | (ppm) | per root | per root |
| TDN | 2000 | 2.01 | 0.15 |
| | 200 | 2.57 | 0.21 |
| | 20 | 1.07 | 0.08 |
| PBZ | 200 | 1.59 | 0.29 |
| | 20 | 1.50 | 0.28 |
| INA | 200 | 1.03 | 0.02 |
| | 20 | 2.28 | 0.22 |
| SA | 200 | 2.17 | 0.44 |
| | 20 | 2.09 | 0.38 |
| Untreated plot | | 2.55 | 0.52 |

### Test Example 2

### Soil Irrigation Treatment

### Method

The red clover seeds were sowed in a pot packed with soil (1/10000 ares) and Orobanche minor seeds were sowed around the red clover seeds, followed by cultivation in a greenhouse. After 10, 20 and 30 days of the sowing, an agent liquid prepared into a predetermined concentration was irrigation-treated at a ratio of 20 ml/pot.

### Results

A dose-related lowering was found by TDN. It was effective at a concentration of 200 ppm or more. Parasitism was hardly found at 2000 ppm of TDN. The parasitism frequency was slightly lowered by the treatment with 200 ppm INA. On the whole, S4 (bud formation) was reduced in all of the treated plots.

TABLE 3
Test on the effect on parasitism of Orobanche minor on red clover
(Soil treatment)

| | | Average | |
|---|---|---|---|
| | Treatment | parasitism | S4 bud |
| | concentration | frequency | formation |
| Agent | (ppm) | per root | per root |
| TDN | 2000 | 0.03 | 0.00 |
| | 200 | 0.53 | 0.16 |
| | 20 | 1.71 | 0.10 |
| | 2 | 2.36 | 0.17 |
| PBZ | 200 | 1.52 | 0.08 |
| | 20 | 3.17 | 0.08 |
| | 2 | 2.47 | 0.13 |
| INA | 20 | 1.03 | 0.08 |
| | 2 | 1.49 | 0.07 |
| SA | 20 | 2.47 | 0.03 |
| | 2 | 1.75 | 0.06 |
| Untreated plot | | 2.55 | 0.52 |

### Test Example 3

### Foliage Application Treatment

### Method

The red clover seeds were sowed in a pot packed with soil (1/10000 ares) and Orobanche minor seeds were sowed around the red clover seeds, followed by cultivation in a greenhouse. After 10, 20 and 30 days of the sowing, sufficient amount of agent liquid diluted to a predetermined concentration with water was applied to the foliage using an atomizer, from single- to double-leaf stage of the red clover.

### Results

A dose-related lowering was found by TDN. A high effect was found at 2000 ppm. However, the parasitism frequency was larger than the case of soil treatment. By the first treatment with 200 ppm of SA, 4/6 and 1/5 of red clover withered in two pots. The parasitism frequency was large by 200 ppm of SA. The parasitism frequency was lowered by INA. However, growth of the host was also inhibited in 200 ppm treatment plot.

TABLE 4
Test on the effect on parasitism of Orobanche minor on red clover
(Foliage treatment)

| | | Average | |
|---|---|---|---|
| | Treatment | parasitism | S4 bud |
| | concentration | frequency | formation |
| Agent | (ppm) | per root | per root |
| TDN | 2000 | 0.24 | 0.03 |
| | 200 | 1.02 | 0.06 |
| | 20 | 1.49 | 0.15 |
| PBZ | 200 | 1.75 | 0.18 |
| | 20 | 2.24 | 0.16 |
| INA | 20 | 0.94 | 0.03 |
| | 2 | 0.99 | 0.05 |
| SA | 20 | 4.05 | 0.38 |
| | 2 | 1.91 | 0.17 |
| Untreated plot | | 2.55 | 0.52 |

### Test Example 4

### Seed Soaking Treatment

### Method

Red clover seeds were soaked for 24 hours in agent liquid which had been prepared into a predetermined concentration. The red clover seeds were sowed in a pot packed with soil (1/10000 ares) and Orobanche minor seeds were sowed around the red clover seeds, followed by cultivation in a greenhouse. Growth of the red clover and the parasitism frequency and growth of Orobanche minor were observed by visual observation.

### Results

A decreasing tendency was found on the total parasitism frequency of Orobanche minor and S4 bud formation in all of the TDN and CICA treatment plots. Phytotoxicity was not found in all of the treatment plots.

TABLE 5
Test on the effect on parasitism of Orobanche minor on red clover
(Seed soaking treatment)

| | | Average | |
|---|---|---|---|
| | Treatment | parasitism | S4 bud |
| | concentration | frequency | formation |
| Agent | (ppm) | per root | per root |
| TDN | 200 | 0.05 | 0.12 |
| | 20 | 1.12 | 0.10 |
| CICA | 200 | 1.15 | 0.09 |
| | 20 | 1.36 | 0.11 |
| Untreated plot | | 2.08 | 0.45 |

### Test Example 5

### Soil Irrigation Treatment

### Method

The red clover seeds were sowed in a pot packed with soil (1/10000 ares) and Orobanche minor seeds were sowed around the red clover seeds, followed by cultivation in a greenhouse. After 10, 20 and 30 days of the sowing, agent liquid prepared into a predetermined concentration was irrigation-treated at a ratio of 20 ml/pot.

### Results

A parasitism frequency reducing tendency was found by 2000 and 200 ppm of TDN and CICA. Also, S4 (bud formation) was reduced in all of the TDN and CICA treatment plots. In this connection, a strong phytotoxicity by 2000 ppm, and a weak phytotoxicity by 200 ppm, of TDN were found, while a weak phytotoxicity was also found by 2000 ppm of CICA. The symptom of phytotoxicity was growth inhibition in all cases.

TABLE 6
Test on the effect on parasitism of Orobanche minor on red clover
(Soil treatment)

| | | Average | | |
|---|---|---|---|---|
| | Treatment | parasitism | S4 bud | |
| | concentration | frequency | formation | |
| Agent | (ppm) | per root | per root | Phytotoxicity |
| TDN | 2000 | 0.22 | 0.07 | ++ |
| | 200 | 1.55 | 0.11 | + |
| | 20 | 2.22 | 0.13 | − |
| CICA | 2000 | 0.15 | 0.04 | + |
| | 200 | 1.39 | 0.09 | ± |
| | 20 | 1.99 | 0.10 | − |
| Untreated plot | | 2.08 | 0.45 | − |

### Test Example 6

### Foliage Application Treatment

### Method

The red clover seeds were sowed in a pot packed with soil (1/10000 ares) and Orobanche minor seeds were sowed around the red clover seeds, followed by cultivation in a greenhouse. After 10, 20 and 30 days of the sowing, sufficient amount of agent liquid diluted to a predetermined concentration with water was applied to the foliage using an atomizer, from single- to double-leaf stage of the red clover.

### Results

Although a parasitism frequency decreasing tendency was found by 2000 ppm of both TDN and CICA, the decreasing tendency was unclear by 200 ppm or less. Additionally, there was a decreasing tendency on S4 bud formation by 2000 and 200 ppm of both TDN and CICA. In this connection, phytotoxicity was not found in all of the treatment plots.

TABLE 7
Test on the effect on parasitism of Orobanche minor on red clover
(Foliage treatment)

| | | Average | |
|---|---|---|---|
| | Treatment | parasitism | S4 bud |
| | concentration | frequency | formation |
| Agent | (ppm) | per root | per root |
| TDN | 2000 | 0.34 | 0.15 |
| | 200 | 1.92 | 0.35 |
| | 20 | 2.25 | 0.49 |
| CICA | 2000 | 0.44 | 0.03 |
| | 200 | 2.05 | 0.25 |
| | 20 | 3.01 | 0.60 |
| Untreated plot | | 2.08 | 0.45 |

While the present invention has been described in detail and with reference to specific embodiments thereof, it will be apparent to one skilled in the art that various changes and modifications can be made therein without departing from the spirit and scope of the present invention.

This application is based on a Japanese patent application filed on Jul. 13, 2006 (Japanese Patent Application No. 2006-193083), the entire contents thereof being thereby incorporated by reference. Additionally, all of the references cited herein are incorporated as a whole.

### INDUSTRIAL APPLICABILITY

According to the present invention, an agent for controlling parasitic plants, which can effectively control parasitic plants parasitizing on crops, and a method for using the same, can be provided.

1. An agent for controlling a parasitic plant, which comprises 1 or 2 or more of compounds selected from tiadinil, probenazole, 2-chloroisonicotinic acid and isotianil, as the active ingredient.

2. The agent for controlling parasitic plant according to claim 1, wherein the object to be controlled is a root-parasitic plant.

3. The agent for controlling parasitic plant according to claim 2, wherein the root-parasitic plant is the genus Striga or the genus Orobanche.

4. The agent for controlling parasitic plant according to claim 1, wherein the active ingredient is tiadinil.

5. A method for controlling parasitic plant, which comprises treating a parasitized plant or soil with an effective amount as the active ingredient of the agent for controlling parasitic plant described in claim 4.

6. The method for controlling parasitic plant according to claim 5, wherein the treatment of a parasitized plant or soil is such a soil treatment that the parasitized plant can absorb the active ingredient from the root parts.

7. The agent for controlling parasitic plant according to claim 4, wherein from 0.01 to 60% by weight of the active ingredient is contained based on the agent for controlling parasitic plant.

8. The agent for controlling parasitic plant according to claim 7, wherein from 0.1 to 50% by weight of the active ingredient is contained based on the agent for controlling parasitic plant.

9. The method for controlling parasitic plant described in claim 5, wherein amount of the active ingredient is from 5.0 to 5000 g per 1 hectare.
